(19) United States
(12) Patent Application Publication
(10) Pub. No.: US 2024/0100528 A1
(43) Pub. Date: Mar. 28, 2024

(54) Improved Thermocycled Multistep Reactions Device

(71) Applicant: QUANTOOM BIOSCIENCES FRANCE SAS, Evry-Courcouronnes (FR)

(72) Inventors: Irina RANDRIANJATOVO-GBALOU, Evry-Courcouronnes (FR); Ahmed SAID, Evry-Courcouronnes (FR); Renaud RAHIER, Evry-Courcouronnes (FR); Alexis JOBARD, Evry-Courcouronnes (FR)

(21) Appl. No.: 18/275,308

(22) PCT Filed: Feb. 4, 2022
(86) PCT No.: PCT/EP2022/052775

§ 371 Date: Aug. 1, 2023

(30) Foreign Application Priority Data
Feb. 5, 2021 (EP) 21305163.4

(51) Int. Cl. B01L 3/00; B01L 7/00

(52) U.S. Cl. CPC B01L 3/50851; B01L 7/52; B01L 2300/0681; B01L 2300/0829; B01L 2300/185

(57) ABSTRACT

Thermocycling multistep reactions device (10) comprising: a reaction plate (12) comprising at least one well (14), at least one internal thermoregulating fluid circulation circuit configured to be arranged in direct contact with the at least one well (14), an evacuation system, a control unit configured to manage the temperature of the internal thermoregulating fluid circuit. The temperature inside the at least one well (14) is regulated and controlled by means of the control unit. Each well (14) is connected to the evacuation system by means of at least one filter membrane, and the thermoregulating fluid circuit is made of a heat conducting material while the reaction plate is made (12) of a polymerous material.

### FIELD OF INVENTION

The present invention relates to devices and methods enabling high-performance, scalable volume and automated handling of biological or chemical samples which are useful in the field of genomics, chemistry and biology for a variety of processes, including large-scale DNA amplification or de novo synthesis, gene expression analysis, chemical synthesis, cell sampling and more particularly when thermocycled multistep reactions are implemented.

### BACKGROUND OF INVENTION

The synthesis of (macro)molecules and polymers, whether carried out chemically, biologically or biochemically, is a fundamental issue in modern industries, such as the pharmaceutical, food or petrochemical industries.

More particularly, the production and synthesis of de novo nucleic acids, whether single or double stranded, or specific cell cultures is today a major pharmaceutical issue since the development of bio-therapeutic technologies such as DNA/RNA vaccines, gene therapy or even cell therapy is taking an unprecedented boom. However, to be industrialized, these technologies require a large amount of genetic material with a high degree of purity, essential criteria to meet GMP standards.

Nowadays, the synthesis of nucleic acids is classically carried out in a chemical way by means of technologies based on the phosphoramidite approach. However, these technologies have the drawback of limiting, either the size of the strand synthesized or the final synthesis yield. Thus for the production of a strand of 120 nucleotides, the final yield is typically less than 50%, without even considering the losses occurred during the purification steps and different necessary treatments to render the final product compatible for a pharmacological application.

The synthesis of oligonucleotides by enzymatic method is therefore becoming an approach of interest. Indeed, certain enzymes naturally have the capacity to lengthen, repair and control nucleic acid sequences, in aqueous solutions that are not very harmful and with higher yields than chemistry.

However, obtaining those (macro)molecules usually require several successive or cyclic synthesis steps which generally further require intermediate purification steps. Thus, beyond the development of the synthesis methods themselves, a major obstacle for the industries to succeed in large-scale synthesis of (macro) molecules and polymers is their lack of means and tools to be able to readily purify the reactions products between each synthesis step, meaning being able to separate the reaction products from unincorporated reagents, synthesis catalysts as well as reaction by-products.

In order to achieve those purification steps, several methods can be used, such as chromatography or electrophoresis (Syrén et al., 2007. J Chromatogr B Analyt Technol Biomed Life Sci. 856(1-2):68-74). However, although these methods are very efficient and generally lead to extremely pure reaction products, the complexity, the implementation time as well as very high cost of those methods, make them difficult to implement at an industrial scale.

This is why industries generally opt for simpler methods, such as filtration and ultrafiltration which allow rapid and less expensive separation of the reaction products from reaction by-products. For this, several types of (ultra)filtration equipment have been developed such as the Amicon® and Centricon® modules, which use centrifugal force. Vacuum filtration devices, powered by a pump are also currently used. Those vacuum pumps allow the creation of a controlled depression between the filtrate (reaction products) and the retentate (reaction by-products). However, although very efficient, those devices are not suitable for carrying out chemical and/or biochemical reactions in the module itself as they do not allow the effective and precise control, and the automatization of the temperature and the homogenization of the reaction medium.

Furthermore, laboratory automation has played a key role in the advancement of genomics, synthetic biology and drug discovery over the past decade. Levels of automation of the various steps vary, ranging from processes including manual steps, e.g., for the feeding of raw materials to fully integrated processes. According to the final purpose, each configuration has demonstrated some advantages; however in cases including some manual setups, there are significant issues with human error-resulting misinterpretation of results, a whole process labor which is more intensive; not to mention the risks of contamination when transferring from one system to another. Other laboratories utilize pipetting robots to accomplish these preparative steps (such as plate-to-plate liquid transfers, plate sealing, plate-thermocycling with magnetic beads, etc.), but these systems are complicated and expensive to build and may suffer from sample evaporation problems and volume constraints.

The current invention aims at solving the above-mentioned issues, by providing a thermocycling multistep reaction device and a method for synthesizing (macro)molecules using said device, such as, for example, nucleic acids, by enzymatic means, in large industrial quantities, with a high level of purity and whose length in sequence is 10 to 20 times longer and higher than chemical synthesis.

The current invention further aims at providing a handy, small, easy to handle and partly disposable device to do so.

### SUMMARY

This invention thus relates to a thermocycling multistep reactions device comprising:
a reaction plate comprising at least one well configured to receive a reaction solution or a reaction tube,
a first fluid circuit and a second fluid circuit each one configured to maintain a fluid at a predetermined temperature,
at least one internal thermoregulating fluid circulation circuit configured to be arranged in direct contact with the at least one well, the thermoregulating fluid circuit being selectively connectable to the at least first fluid circuit and the second fluid circuit,
an evacuation system,
a control unit configured to manage the selectable connection of the at least two fluid circuits to the internal thermoregulating fluid circuit in order to regulate and control the temperature inside the at least one well.

Each well is connected to the evacuation system by means of at least one filter membrane, and the thermoregulating fluid circuit is made of a heat conducting material while the reaction plate is made of a polymerous material, the reaction plate at least partially enclosing the thermoregulating fluid circuit in order to at least partially isolate said thermoregulating fluid circuit from the external environment.

This way, the solution enables to reach the here-above mentioned objective. Especially, solving the quantity and purity issues through the development of a temperature controlled modular vacuum filtration device that can accommodate one or several independent reaction chambers embodied by each well. The reaction temperature inside each reaction chamber is thus controlled by the circulation of a fluid in the heart of the device, enabling a series of controlled temperature variations depending on the reaction parameters. On the other hand, the products purity is controlled by the controlled use of a specific membrane with determined pore size. Further, if the device is installed on a steering system, the chemical and thermal homogenizations of the reaction medium can safely be obtained by orbital or linear stirring without the need to move the device. There is thus no necessity to transfer the reaction solution from a first device to a second device, to a further device between different reaction and/or purification steps. This, among other obvious safety and productivity advantages, enables all of those steps to be automated.

Furthermore, the small size and little weight of the device enables easy, safe and handy handling inside any kind of laboratory.

Thus, the device according to the present invention is particularly suitable, but not limited to the controlled synthesis of nucleic acids.

The device according to the invention may comprises one or several of the following features, taken separately from each other or combined with each other:
each well and the internal thermoregulating fluid circulation circuit may be comprised in a same plane, said plane being defined by the reaction plate,
the reaction plate may be configured to enable a radial heat diffusion between each well and the thermoregulating fluid circuit, said diffusion being thus parallel to the plane defined by the reaction plate,
the reaction plate further may enclose the evacuation system in order to at least partially isolate said evacuation system from the external environment,
the evacuation system may comprise a vacuum pump,
each well may display an internal and an external surface, the external surface of each well being in direct contact with the thermoregulating fluid circuit,
the external surface of each well may be defined within the reaction plate, the reaction plate thus comprising the external surface of each well,
each well may be defined within the thermoregulating fluid circuit, the thermoregulating fluid circuit thus comprising the external surface of each well,
any heat diffusion between each well and the thermoregulating fluid circuit is a direct diffusion,
the reaction plate, the evacuation system and the thermoregulating fluid circuit may be separable from each other,
the first fluid circuit may define a first predetermined temperature which ranges from about 90 to about 110° C.,
the second fluid circuit may define a second predetermined temperature which ranges from about −150 to about 20° C.,
the device may comprise one filter membrane for each well, each filter membrane connecting its corresponding well to the evacuation system,
the dimensions of the complete device comprise a high of maximal 14 cm.

A further object of the present invention is a thermocycling multistep reactions system comprising a thermocycling multistep reaction device according to any one of the preceding technical features, and a pipetting robot. The pipetting robot is configured to fill or refill in an independent and automated way each of the wells of the thermocycling multistep reaction device (10).

### BRIEF DESCRIPTION OF THE DRAWINGS

The invention will be better understood, and other aims, details, characteristics and advantages thereof will emerge more clearly on reading the detailed description which follows, of one or several embodiments of the invention given by way of illustration. Those are purely illustrative and non-limiting examples, with reference to the accompanying schematic drawings.

On these drawings:

FIG. 1 is a perspective view of one embodiment according to the present invention in which the reaction plate is made transparent,

FIG. 2a is a perspective view of the thermoregulating fluid circuit according to same embodiment as on FIG. 1, reaction tube being inserted in each well,

FIG. 2b is a perspective view of the thermoregulating fluid circuit according to the embodiment of FIG. 2a,

FIG. 3a is a perspective view of the reaction plate comprising the evacuation system of the embodiment of FIG. 1,

FIG. 3b is the same view as FIG. 3a, wherein the reaction plate carries reaction tubes,

FIG. 4 is a perspective view of a second embodiment according to the present invention, in which the reaction plate is made transparent,

FIG. 5 is a central cut view, according to a central cutting plane along a wells line of the embodiment of FIG. 4,

FIG. 6 is another central cut view according to another central cutting plane along a line between two well lines of the embodiment of FIG. 4,

FIG. 7 is a longitudinal cut view according to a longitudinal cutting plane of the embodiment of FIG. 4.

FIGS. 8a and 8b are a schematic representation of a reaction carried out in a device according to the present invention.

### DETAILED DESCRIPTION

As can be seen on FIG. 1, the present invention relates to a thermocycling synthesis device 10 comprising:
a reaction plate 12 comprising at least one well 14 configured to receive a reaction solution or a reaction tube,
at least one internal thermoregulating fluid circulation circuit 16 configured to be arranged around the at least one well 14,
an evacuation system 18,
a control unit (not represented).

The thermocycling synthesis device 10 further comprises a first fluid circuit and a second fluid circuit each one configured to maintain a fluid at a predetermined temperature.

The thermoregulating fluid circuit 16 is selectively connectable to the at least first fluid circuit configured to maintain a fluid at a first predetermined temperature, and the second fluid circuit configured to maintain a fluid at a second predetermined temperature. In some embodiments, the thermoregulating fluid circuit 16 is selectively connectable to three fluid circuits.

The control unit 20 aims at managing the connection of the different fluid circuits to the thermoregulating fluid circuit 16, thus controlling and regulating the temperature inside each well 14 of the reaction plate 12.

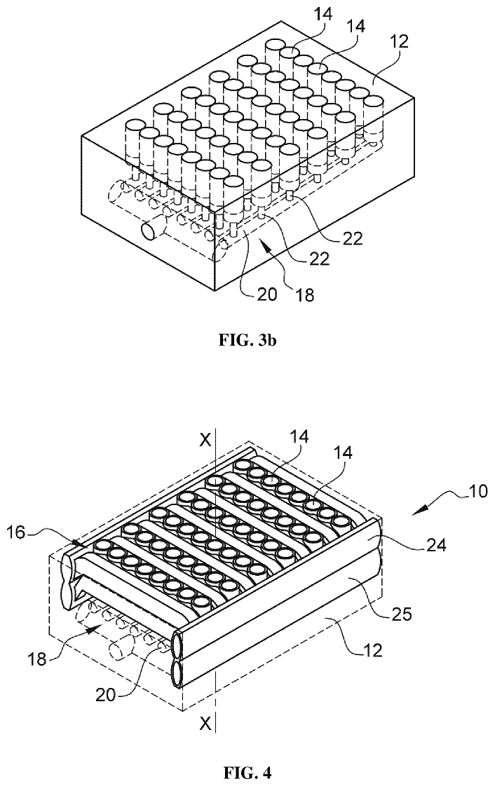

As can be seen on FIGS. 1, 3b and 3a, the reaction plate 12 extends within an agitation plane A, the device 10 being agitated within this plane. The device 10 further extends along a stacking axis X, said stacking axis X being perpendicular to the agitation plane A. In most cases, the agitation plane A is horizontal and the stacking axis X is vertical.

The reaction plate 12 is entirely made of polymers such as polyetheretherketone or polyamide-imides.

This way, contrary to systems made of metal blocks in which channel have been drilled to allow the fluids to circulate, leading to a very heavy device which might be difficult to incorporate into stirring system, but also leads to heat dissipation which can be troublesome for the proper functioning of other components of the device, the present invention, by displaying a reaction plate made of polymers, makes it possible to circumvent these problems.

The polymerous reaction plate 12 leads to a very light reaction plate 12. This further leads to a device 10 which enables safe handling as the isolating reaction plate 12 avoids any risks of burning through very high or very low temperatures. It further prevents the device 10 to act like a heart or a freezer and improves the general comfort inside the laboratory. It also prevents the necessity to use a huge amount of heat transfer fluid in order to heat or cool the device as the temperature sensitive surfaces or elements are limited. In some embodiments, the reaction plate 12 is discardable.

The dimensions of the reaction plate 12 illustrated on the figures are:
Height: 44.1 mm,
Width: 85.5 mm,
Length: 127.8 mm.

The dimensions of the complete device 10 comprise a maximal high of 14 cm in order to easily fit any kind of pipetting robot displaying standardize dimensions. Such an easy fit greatly facilitates the automatization possibilities of the thermocycling processes for which the device 10 is used.

Depending on the targeted biological or chemical reaction chain, other dimensions are possible. However, the reaction plate 12 preferably displays the generic SBS format which enables the use of classical multichannel pipettes and further enables automatization of the well filling. The ANSI/SBS format is a well-known, by any person skilled in the art, standardization of microplates. Microplates are essential in research and development regarding biology. The ANSI/SBS standard was created to regulate their format and to enable the development of tools capable of supporting those microplates. The use of the ANSI/SBS format in the present invention allows it to be adapted to all the current robotic platforms (for example liquid handling robot) of the state of the art.

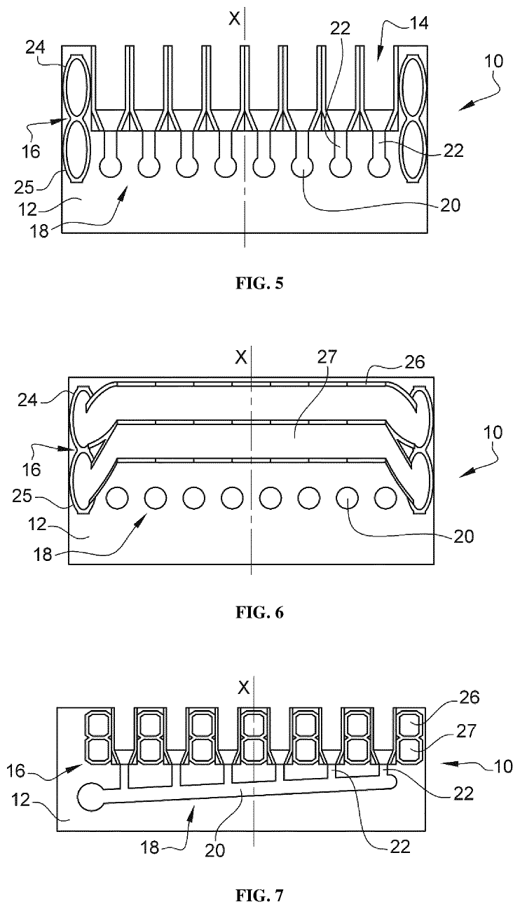

As can be seen on the embodiment depicted on FIGS. 3b and 3a, the reaction plate 12 comprises 24 wells. In another not represented embodiment, the reaction plate 12 can comprise 48 wells. As can be seen on FIG. 5, each well 14 extends along the stacking axis X and 14 displays a general frustoconical shape, the lower extremity of the well displaying a smaller diameter than the upper extremity. Alternatively, the wells 14 may display a general bottle shape a general bottle shape with a narrow neck on the upper side of the reaction plate 12 and a wider reservoir on the lower side of the reaction plate 12. The reaction solution is this introduced through the upper extremity well 14.

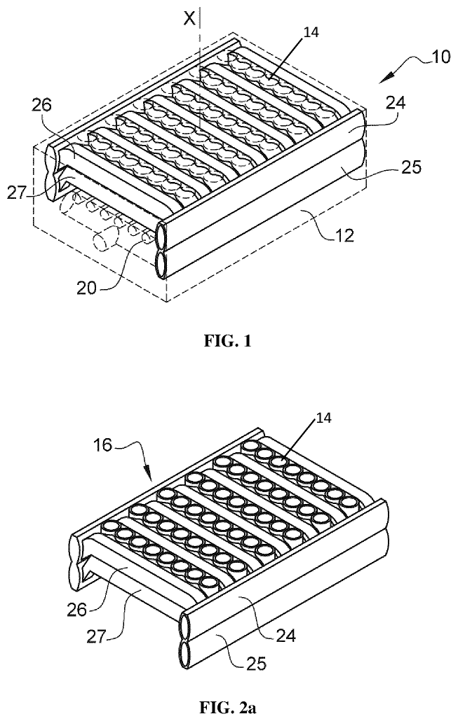

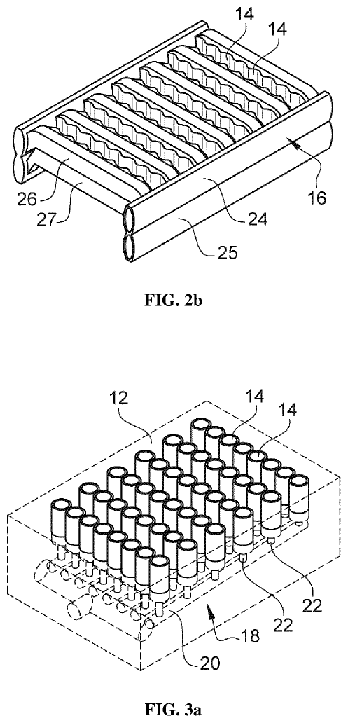

In some alternative embodiments, as illustrated on FIGS. 2a, 3a and 4, each well 14 is able to receive a reaction tube filled with the reaction solution.

Each well 14 thus forms an independent reaction chamber configured to, regarding the embodiments, either directly receive the reaction solution, or receive a reaction tube filled with the reaction solution.

In the embodiment shown on FIGS. 1 and 3b, each well 14 preferably displays an internal coating suitable for the reaction, said internal coating enabling to prevent non-specific adsorption, on the well 14 walls, of reagents and reaction products. For example, the internal coating may comprise hyperhydrophobic coatings of the “low bind” type, such as Teflon®. The internal coating can also display a significant impact in the total elimination of reaction or washing solutions, for example in avoiding wetness and leading to zero drop remaining attached to the walls once the well 14 is emptied.

In the embodiments shown on FIGS. 2a, 3a and 4, each well 14 aims at receiving a reaction tube and does not need any special inner coating.

Each well 14 offers a volume ranging from about 250 to about 500 μL, depending on the number of wells 14 on the reaction plate 12.

The wells 14 should be dimensioned such as to allow the use of a synthesis support, such as a bead. This type of method is observed in particular for the synthesis of PCR primers (100 nucleotides) but also for peptide synthesis (Fmoc chemistry) or even in vitro synthesis of proteins (cell-free system) or other types of polymers. The use of beads also makes it possible to consider protocols for the purification of proteins, nucleic acids or other compounds.

Regardless of the embodiment, each well 14 displays an internal surface (for example a special coating) and an external surface.

Depending on the embodiments, each well 14 is either:
defined within the reaction plate 12, the reaction plate 12 thus comprising the external surface of each well 14 (see FIGS. 1, 3b, 3a), or
is directly defined within the thermoregulating fluid circuit 16, the thermoregulating fluid circuit 16 thus comprising the external surface of each well 14 (see FIGS. 2b, 2a, 4).

In case the well 14 are defined inside the reaction plate 12, each external surface of each well 14 is nevertheless in direct contact with the thermoregulating fluid circuit 16, as can be seen on FIG. 1.

In case the well 14 are defined within the thermoregulating fluid circuit 16, each well 14 solely aims at receiving a reaction tube (see FIGS. 2a and 4). This may also be a possibility for the wells 14 defined within the reaction plate 12.

As can be seen on FIGS. 3b and 3a the evacuation system 18 is situated inside and may be completely integrated in the reaction plate 12, under the wells 14 regarding the stacking axis X. More generally speaking, the reaction plate 12 encloses the evacuation system 18 in order to at least partially isolate said it from the external environment.

Each well 14 is thus connected to the evacuation system 18 by its lower extremity. As can be seen on FIGS. 3b, 3a, the evacuation system 18 may comprise an evacuation channel 20 connected, by means of a quick-coupling 22 to each well 14. The convergence point at which all the quick coupling 22 join each other is situated below the wells 14 in order to avoid any backflow possibility once any fluid has left its well 14 and has entered the evacuation system 18. When activated, the evacuation system 18 enables to empty the wells 14 by evacuating the reaction solution. The evacuation system 18 may be activated by a vacuum pump (not represented) creating a vacuum sucking of the reaction solution out of the wells 14 into the evacuation channel 20 towards a collector (not shown). The general design of the evacuation system 18 is thus globally spherical in order to avoid angles which might, under vacuum, be damaged, thus weakening the evacuation system 18 in its whole. As well known in the related state of the art, a spherical shape would enable a better repartition of the constraints induced by the vacuum on the walls of the evacuation system 18. The collector may display a storage capacity of 15 to 20 L of solution. This allows a high number of cycles to take place without any need to change the collector. All the evacuated fluids are thus collected in one point, which facilitates de recovering or discarding of the evacuated fluid(s). All this allows an easy automatization of the thermocycling process.

It is to be noted that the evacuation system 18 might be considered as a discarding system or a collecting system, depending on which elements are to be kept after the thermocycling process.

Regarding the embodiments configured to receive reaction tubes, each tube is also connected to the evacuation system 18. In order to ensure the vacuum when the evacuation system is activated, each reaction tube is placed in a corresponding well 14 and rest on a seal.

As both the thermoregulating fluid circulation circuit 16 and the evacuation system 18 are enclosed in the reaction plate 12, special care has been taken so that the fluid circulation circuit 16 does not interfere with the channels configured to evacuate the reaction waste from evacuation system 18.

As already mentioned, the thermoregulating fluid circulation circuit 16 is selectively connectable to different fluid circuits. Each of the fluid circuits comprises an external channel (not represented) arranged outside the reaction plate 12. Those external channels are completely separated from each other. Each of the external channels is connected to a pump (not represented) configured to circulate, through each of them independently, heat transfer fluid. Each external channel further comprises a thermostat (not represented) enabling the heat transfer fluid of each of fluid circuits to be maintained at a predetermined temperature.

The thermoregulating fluid circulation circuit 16 further comprises at least two internal peripherical fluid circulation channels 24, 25 arranged in the periphery of the reaction plate 12 (see FIGS. 5 and 6), around the wells 14. The internal peripherical fluid circulation channels 24, 25 are comprised in the same plane as the wells 14. This plane is defined by the reaction plate 12, parallel to the agitation plane A. The fluid circulating in the first internal peripherical fluid circulation channel 24 circulates in the opposite direction that the fluid circulating in the second internal peripherical fluid circulation channel 25. This cross fluidic circulation leads to a better temperature homogenization.

The reaction plate 12 is thus enclosing at least a part of the thermoregulating fluid circuit in order to at least partly isolate said thermoregulating fluid circuit from the external environment.

Those two internal peripherical fluid circulation channels 24, 25 are selectively connected to fluid circuits and can thus be filled with heat transfer fluid at different temperatures, depending on the management of the control unit 20.

The two internal peripherical fluid circulation channels 24, 25 are further connected to internal central fluid circulation channels 26, 27 (see FIG. 1). The fluid circulating in the first internal central fluid circulation channel 26 circulates in the opposite direction that the fluid circulating in the second internal central fluid circulation channel 27. This cross fluidic circulation leads to a better temperature homogenization.

Depending on the embodiments, the central fluid circulation channels 26, 27 either define the wells 14 or are in direct contact with said wells 14 (see FIGS. 5, 6 and 7). The central fluid circulation channels 26, 27 thus also are comprised in the same plane as the wells 14 and the internal peripherical fluid circulation channels 24, 25. As previously mentioned, this plane is defined by the reaction plate 12, parallel to the agitation plane A. In any case, the external surface of the wall of each central fluid circulation channels 26, 27 is in direct contact with each well 14, either with its external surface (see FIGS. 1 and 7) or with its internal surface (see FIGS. 4 and 5). This leads to each well 14 being in direct contact with a primary heat/cold source, without any necessity of an intermediate temperature diffusing element. This further allows the heat to diffuse radially, along the agitation plane A, either from the central fluid channels 26, 27 towards the wells 14 or from the wells 14 towards the central fluid channels 26, 27. This highly increases the temperature homogeneity within each well 14 and avoids the typical temperature inhomogeneities associated to a single heat source situated at one extremity of the well, which necessitates a waiting time until the right temperature has adjusted in each well along the stacking axis X.

Thus, when one of the different circuits is connected, by the control unit, to the two internal peripherical fluid circulation channels 24, 25, heat transfer fluid at the predetermined temperature circulates through the two internal peripherical fluid circulation channels 24, 25 towards the central fluid circulation channels 26, 27 and thus circulating in contact with the wells 14. Depending on the temperature to be achieved in the wells 14, each peripherical fluid circulation channels 24, 25 can be independently connected to one or several of the fluid circuits.

This leads the temperature inside the wells 14 to be precisely regulated and controlled by means of the control unit, more precisely by means of the heat transfer fluid management circulating (or not), in the reaction plate 12, between the wells 14. This heat transfer fluid management is done by the selective activation of one or several of the fluid circuits in order to set and maintain a predetermined reaction temperature request by a reaction protocol. The predetermined reaction temperature is thus obtained by selectively mixing fluids from the different fluid circuit, each fluid circuit being at a predetermined temperature.

The first predetermined temperatures of the first fluid circuit ranges from about 90 to about 110° C., more specifically the first predetermined temperature of the first fluid circuit is about 95° C. The second predetermined temperatures of the second fluid circuit ranges from about −150 to about 20° C.

Temperature control is essential during any kind of chemical or biological synthesis, and in particular for enzymatic synthesis. In particular regarding the enzymatic synthesis of nucleic acids, temperature control is essential for two main reasons:
an enzyme has an optimum temperature for which its activity will be the most efficient,
temperatures ranging from about 90 to about 110° C. denature the nucleic acid strands and keep them in this state to ensure that they are taken care of by the enzymes.
temperatures ranging from about −150 to about 20° C. stabilize nucleic acid strands, more particularly ribonucleic acids, and keep them in this state to ensure that no degradation occurs during storage.

The heat transfer fluids may all be different fluids or may all be the same. It might for example be water, as water is a very good heat transferring fluid and displays no particular danger except the heat regarding the temperature of the fluid inside the heating circuit 20.

Using the same heat transfer fluid also avoids the mixing of different fluids inside the internal fluid circulation channels 24, 25, 26, 27.

In other embodiments, the fluid may be specialized in heat transfer, such as DW-therm (Huber® m90.200.02) and the cooling circuit 22 may thus enable the temperature of the wells 14 to lower down to −150° C. In this embodiment, the heating circuit may enable the temperature of the wells 14 to rise up to 150° C. in less of 1 minute.

Thus, depending on the chemical resistance of the membrane(s) 28 used, the present synthesis device 10 is very suitable for the synthesis of nucleic acids by enzymatic or chemical means, the two procedures being similar. In addition, the possibility of working at temperatures of −20° C. also makes it possible to automate certain molecular biology protocols such as DNA precipitation with ethanol. Conversely, the possibility of varying the temperature also makes it possible to consider carrying out polymerase chain reactions (PCR) or rolling circle amplification (RCA).

As already mentioned, the device 10 is not entirely composed of a metal block but of a die-cast aluminum thermoregulating fluid circuit 16, housed in (depending on the embodiments, it might be integrated into) the polymer reaction plate 12. This aluminum thermoregulating fluid circuit 16 being direct contact with the wells 14 allows good local heat exchanges while being isolated, at least partially, from the external environment in order to protect any user and improve safety and using comfort regarding extreme temperatures.

The thermoregulating fluid circuit 16 includes a cross circulation system to promote good temperature homogeneity and an accelerated transition between two temperature values. The advantage of the present device 10 displaying a reaction plate 12 and a thermoregulating fluid system 16 made of two different materials with different property regarding heat transfer and isolation, is that it provides localized heat input in the reaction chamber, with low heat dissipation. The fact of reducing the metal parts to a minimum also generates significant weight reduction and leads the device 10 to be compatible in terms of mass with the steering systems on the market.

In some embodiments, a steering system is integrated in the device 10 and is to be found under the reaction plate 12, as a separated functional bloc. This integrated steering system enables the chemical and thermal homogenizations of the reaction medium inside the wells 14 of the reaction plate 12 by orbital or linear stirring. The steering system might be a Hamilton® system. In an alternative embodiment, the device 10 may be safely secured on an independent steering system.

As can be seen on FIGS. 3b, 3a, each well 14 is connected to the evacuation system 18 by means of at least one filter membrane 28. Regarding the embodiments configured to receive reaction tubes, each tube is also connected, through the membrane 28 to the evacuation system 18.

This way, the device 10 integrate a vacuum filtration or ultrafiltration system (said (ultra) filtration system comprising the evacuation system 18 and each filter membrane 28) enabling a total separation of the reaction product of interest and reaction waste, without producing any dead volume. The purpose of the ultrafiltration system in the context of the synthesis of nucleic acids, for example, is to keep the reaction product of interest fixed on a soluble support, meaning a filter membrane 28, while the used synthesis mixes pass, through vacuum suction (induced by the activation of the evacuation system 18), with the aqueous phase through the membrane 28, towards the evacuation system 18, and are then removed. Alternatively, the reaction product reaction may be recovered from the collector, if it is the remaining reaction solution which is held captive from the membrane 28. This is the case when the reaction inside the well 14 includes some cell culture or some bigger molecule degradation in order to obtain a smaller molecule of interest.

The device 10 comprises one filter membrane 28 for each well 14, each filter membrane displaying a size sensibly similar to the well lower reservoir 14b diameter.

The panel of membranes 28 that can be adapted to the device 10 is very wide. The membranes 28 can have pore sizes ranging from 3 kDa to 100 kDa for ultrafiltration and up to 1 μm for simple filtration. In cases where beads are used inside the wells 14, the pores of the membrane 28 can be large, around 1 um.

The membranes 28 can be of organic, inorganic or hybrid type and thus have variable chemical compositions. More particularly, the device 10 may comprise membranes 28 based on phlysophone (PS), polyethersulphone (PES), polyvinylidene fluoride (PVDF) polyacrylonitrile (PAN) and cellulose acetate (CA), Polytetrafluoroethylene (PTFE) but also based on ceramics, aluminum, zircon, titanium oxide, silica, mixture of silicon carbide and clay.

The main innovation of the present device 10 lies in its ability to integrate, in a safe and handy way, in the same device or around the same device, three essential properties for the good progress of a chemical or biochemical reaction process:
1) precise and accurate temperature control,
2) homogenization of the solution via agitation, and
3) the possibility of filtering the solution in order to purify the reaction product.

Each of these criteria can be individually validated by different devices or system of the state of the art. Of course, there are many ultrafiltration, agitation or thermoregulation systems in the state of the art. However, none of them can do all of these three tasks at the same time.

As the reaction solution does not need to be transferred to another reactor during a chemical or biological process, the device 10 according to the present invention can also easily be automated for any step of the process, from the well filing by pipetting and the retrieval of molecules of interest after the process.

Regarding automatization, the thermocycling multistep reaction device 10 according to the present invention can be part of a thermocycling multistep reactions system further comprising a pipetting robot. In this automated configuration, the pipetting robot is configured to fil or refill in an independent and automated way each of the wells 14 of the thermocycling multistep reaction device 10 before and/or during a thermocycling process.

This combination, in one and the same device, has an undeniable advantage since it makes it possible to reduce product losses, in particular by avoiding transferring the reaction medium from one tube to another. This allows a saving of time and significant yield. With the easy possibility of automation, especially when the synthesis requires several reaction cycles, such as the synthesis of nucleic acids which can reach more than 20,000 successive steps, a significant amount of time can be saved.

The device 10 according to the present invention enables the implementation of a thermocycling multistep reaction method, said method comprising, in the order of listing, following steps:
filing the fluid circuits with one or several heat transfer fluid(s) and activating them,
inserting, if necessary, a reaction tube inside the at least one well 14 and positioning the at least filter membrane 28 between the at least one well 14 and the evacuation system 18,
filing each well 14 with either a reaction solution or a reaction tube comprising the reaction solution,
selectively activating and disactivating over time, by means of the control unit, the different fluid circuits according to a predetermined reaction protocol,
activating the evacuation system 18 when all the reaction steps according to reaction protocol are completed,
recovering the reaction product hold captive in the membrane 28 or collected in the collector.

By way of example, the thermocycling multistep reaction method is suitable for synthesis processes of organic molecules or macromolecules, which include one or a series of chemical or enzymatic reactions carried out to prepare either a single organic molecule, a library of molecularly identical organic molecules or a library of molecularly diverse organic molecules, wherein the chemical or enzymatic reactions are sequentially or cyclically performed. Such synthesis process can be implemented for the production of organic molecules such as biomolecules, including peptides, nucleic acids molecules (including DNA, RNA and mixes thereof), carbohydrates, and conjugates thereof; but could also be applied for synthesis of any other organic molecule.

Examples of synthesis process include de novo (or template-independent) synthesis, template-dependent synthesis and nucleic acid assembly.

The term “de novo synthesis” refers to a process of synthesizing an organic molecule of any length by iteratively linking organic molecule building blocks until the desired polymeric organic molecule is obtained. De novo synthesis processes apply to any type of polymeric organic molecules, including peptides, nucleic acids molecules, carbohydrates, and conjugates thereof. In de novo synthesis, the sequence of the newly synthesized organic molecule is not dictated by any template.

In the case of de novo synthesis (i.e., without template), the process typically involves the following steps which can all be carried out in the device 10 according to the invention—although one or more of these steps can be modified or adapted depending on the organic molecule to be synthesized, as will readily be apparent to the one skilled in the art:
(a) providing a synthesis initiator;
(b) contacting said synthesis initiator with at least one organic molecule building block comprising a protecting group, in conditions suitable to couple the organic molecule building block with the synthesis initiator, thereby obtaining a protected coupling product;
(c) washing the excess of protected organic molecule building block;
(d) contacting the protected coupling product with at least one deprotecting reagent in conditions suitable to remove the protecting group from the protected coupling product, thereby completing a cycle of synthesis of a polymeric organic molecule;
(e) repeating steps (b) to (d) until the desired polymeric organic molecule is obtained.

It is to be understood that the term “organic molecule building block” refers to any organic molecule, which upon sequential or cyclical coupling to other organic molecules will form a corresponding polymeric organic molecule. Typically, organic molecule building blocks include natural or synthetic building blocks, such as amino acids, nucleotides, nucleosides, monosaccharides and derivatives or analogs thereof. However, the term “organic molecule building block” may further include dimers, trimers and the like.

In one embodiment, the organic molecule building block is selected from the group comprising or consisting of an amino acid, a peptide, a nucleotide, a nucleoside, and a saccharide. In one embodiment, the protected organic molecule building block is selected from the group comprising or consisting of an N-protected amino acid, an N-protected peptide, an O-protected nucleotide, an O-protected nucleoside and an O-protected saccharide.

It is further to be understood that the term “polymeric organic molecule” refers to any organic molecule, which may be formed upon sequential or cyclical coupling to organic molecule building blocks. The nature of the polymeric organic molecule is dependent upon the identities of the organic molecule building blocks. Typically, polymeric organic molecules include biomolecules, such as, e.g., peptides, polypeptides, oligonucleotides, polynucleotides, oligosaccharides and polysaccharides. Also encompassed are conjugates thereof, such as, e.g., peptide-oligonucleotides conjugates, peptide-polysaccharide conjugates, oligonucleotide-oligosaccharide conjugates, and the like.

The term “template-dependent synthesis” applies typically to the synthesis of nucleic acids, and refers to a process that involves the synthesis of a nucleic acid strand that is complementary to a template strand of interest. In template-dependent synthesis, the sequence of the newly synthesized nucleic acid strand is dictated by complementary base-pairing with the template strand of interest.

In the case of template-dependent synthesis, and in particular in the field of nucleic acid synthesis, the process typically involves the following steps which can all be carried out in the device 10 according to the invention—although one or more of these steps can be modified or adapted as will readily be apparent to the one skilled in the art:
(a) providing a nucleotide, oligonucleotide or polynucleotide serving either as:
   a primer for synthesis of a nucleic acid strand which is complementary to at least a portion of a free nucleic acid template hybridized to said primer; or
   a nucleic acid template for synthesis of its free complementary nucleic acid strand;
(b) contacting said nucleotide, oligonucleotide or polynucleotide with at least one organic molecule building block, in particular nucleotides or nucleosides, in conditions suitable to either:
   couple the organic molecule building blocks with the nucleotide, oligonucleotide or polynucleotide serving as a primer in a complementary fashion to the free nucleic acid template; or
   couple the organic molecule building blocks to one another in a complementary fashion to the nucleotide, oligonucleotide or polynucleotide serving as a nucleic acid template;
(c) repeating step (b) until the desired nucleic acid molecule is obtained.

Typical examples of template-dependent synthesis include enzymatic amplification processes, such as polymerase chain reaction (PCR) which allows to synthetize a DNA (using, e.g., a DNA or RNA-dependent DNA polymerase) or RNA (using, e.g., a DNA or RNA-dependent RNA polymerase) strand from a nucleic acid template (such as, a DNA template or an RNA template).

The term “nucleic acid assembly” applies typically to the synthesis of nucleic acids, and refers to a process of assembling a plurality (i.e., two or more) small nucleic acid fragments to produce a longer nucleic acid fragment, using extension-based multiplex assembly reactions, ligation-based multiplex assembly reactions, or a combination thereof, in the presence of a ligase.

The thermocycling multistep reaction method is also suitable for performing molecular biology and biochemistry assays, such as, e.g., ligand-binding assays including nucleic acid hybridization assays, affinity purification, and the like.

The term “ligand binding assay” refers to a biochemical test relying on the binding of ligands to a target molecule, such as a receptor, an antibody or any other macromolecule, e.g., for screening, detecting and/or quantifying a ligand molecule binding to a given target molecule. The term “nucleic acid hybridization assay”, or in short “hybridization assay”, refers to a specific type of ligand binding assay in which the annealing of two complementary strands of nucleic acids is detected. The term “affinity purification” refers to a variant of a ligand binding assay in which a biochemical mixture is separated, based on a specific interaction between a ligand and its target molecule.

In any of the above embodiments, the method may comprise one or several downstream applications on the reaction product before it is recovered. Classical downstream applications are, for example, on-site mutagenesis, screenings, sequencing via Oxford Nanopore technology, in particular thanks to the use of the MinION® range (sequencing from linear double-stranded DNA), RNA transcription and synthesis steps, post-synthetic labelling, secured storage at low temperature without sampling and transfer.

It is also common that the reaction solution, comprising the reaction product or its intermediate product(s), be washed, once or several times throughout the method. Typically, water or buffer can be added to the reaction product in the at least one well 14 or in the reaction tube inside the at least one well 14, and the reaction medium is then filtrated by means of the filter membrane 28 in activating the evacuation system 18. A typical washing cycle includes 2, 3 or more reiterations in a row of adding water or buffer and filtrating.

More precisely, a typical example of a thermocycling synthesis method is a scalable PCR-prep (endotoxin free/LPS free/host genome free) and direct circular plasmid production. A non-limiting example of plasmids that can be amplified using this method includes plasmids used for viral vector production. For instance, in the case of recombinant adeno-associated viral (AAV) vectors carrying a transgene of interest, production can be achieved by transfecting cells with a “rep/cap plasmid” (also termed “AAV helper plasmid”) containing the AAV rep and cap genes required for replication and capsid formation and an “AAV transfer plasmid” containing the transgene of interest flanked on both sides by inverted terminal repeats (ITRs); the cell may further be transfected with an “adenovirus (Ad) helper plasmid” containing the necessary adenovirus helper genes (in particular the virus-associated “VA” RNA, E2A and E4 genes), or alternatively be infected with a helper virus, or still alternatively, the Ad helper genes can be introduced in the AAV helper plasmid. The skilled artisan is familiar with AAV vector production.

Currently, DNA-Prep (e.g., Mini to Giga-Prep) is the most commonly used method for plasmid amplification. Robust protocols allow the obtention of high quantities of pure plasmid, easily scalable from lab bench to industrial bioreactors. However, this method is slow, labour intensive and relies on the use of bacteria, which implies an antibiotics selection step followed by an overnight culture step and finally the purification of the plasmid itself. This latter step is critical as the plasmid needs to be purified from bacterial contaminants such as genomic DNA, RNA, proteins and endotoxins.

To overcome these problems, the current device 10 enables the implementation of a fully automated synthesis method that allows high yields DNA preparations. This method is based on a process that involves a PCR-mediated amplification step followed by a sealing circularization step. Another method involves a thermostable DNA ligase that can be directly included in the PCR reaction buffer to realize a one-pot DNA-prep.

This method comprises two phases: an amplification phase by PCR, and a circularization phase by DNA-ligation. Both phases are implemented by means of the device 10 according to the current invention.

### Amplification Phase 34 by PCR

### Materials

thermocycled synthesis device 10,
PolyEthersulfone (PES) membrane 28 with a cut-off of 100 kDa,
Primers (forward and reverse), optionally phosphorylated,
Plasmid DNA or minicircle template (>2.5 kb),
High fidelity Polymerase (e.g., Q5® High-fidelity DNA polymerase, from New England Biolabs),
PCR buffer,
dNTPs mix,
DNase-free water.

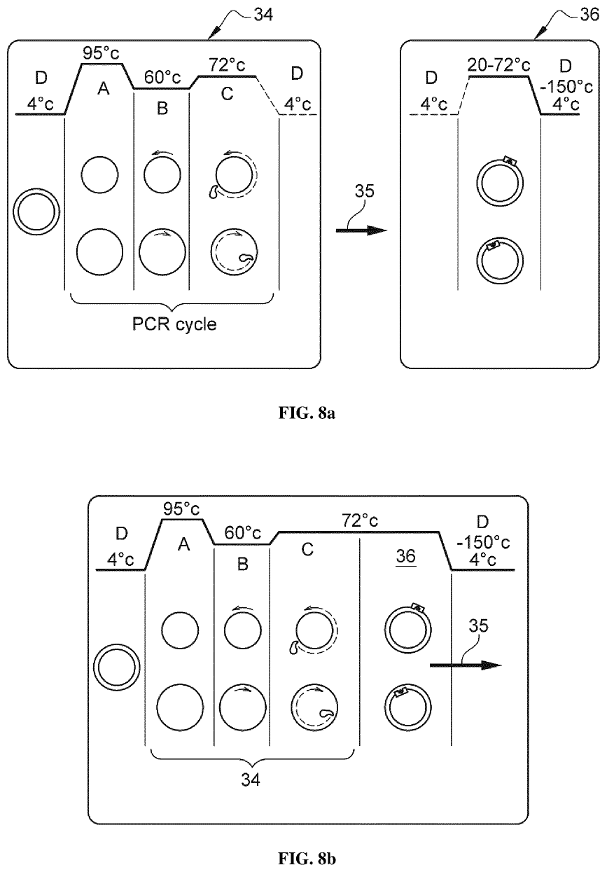

The amplification phase 34 comprises at least one PCR cycle. As can be seen on FIG. 8a, a PCR cycle comprises three phases: a denaturation phase A happening at 95° C., an annealing phase B happening at 55-70° C. and an elongation phase C happening at 72° C. FIG. 8a also shows several storage phases D which might happen at different stages of the reaction. After at least 1 to 35 PCR cycles there is the possibility to filtrate 35 the reaction solution by means of the filter membrane 28 in activating the evacuation system 18 and thus to remove the reaction solution, in particular the primer, the dNTPs, the polymerase, and the salts, and to either pursue to the next step or to repeat one or several other PCR step(s) to increase the amount of DNA product and to remove harmful by-products, e.g., pyrophosphate may inhibit the enzymatic reaction even at very low concentrations. It has been recognized that pyrophosphorolysis, where a nucleic acid is reduced in length, is detrimental to primer extension reactions. Previous studies and invention have been assessed to overcome those limitations in adding some further reactants, which leads to a complication of the reaction protocol. The present invention enables to overcome those limitation in an easier and more efficient way.

### Circularization Phase 36 by DNA-Ligation

### Materials

DNA ligase (e.g., T4 DNA ligase, ATP-dependent thermostable ligase or NAD-dependent thermostable ligase such as the HiFi® Taq DNA ligase),
Example of buffer composition: 10 mM Tris-HCl, 50 mM KCl, 1 mM DTT, 0.1 mM EDTA, 50% glycerol,
Optionally, a DNA kinase when non-phosphorylated primers are used,
DNAse-free water.

If the used primers are not phosphorylated, the DNA kinase allows the phosphorylation of the 5′ ends of the double strand DNA. Thus, a DNA ligase is able to catalyse the formation of a phosphodiester bond between adjacent 5′-phosphate and 3′-hydroxyl groups of duplex DNA. This step allows the closing of the vector from linear to circular. It can be performed with different kind of ligases and at different temperatures, including T4 DNA ligase at 20° C., an ATP-dependent thermostable ligase at 70° C. or a NAD-dependent thermostable ligase at 70° C., such as the HiFi® Taq DNA ligase.

A final purification step through filtration 35 and DNA washing is performed to remove salts, enzyme(s), nucleotides and reaction by-products.

An alternative of this method is illustrated in FIG. 8b and consists in performing a one-pot plasmid amplification and circularization by adding a thermostable NAD-dependent ligase. Such a method requires two essential features that are (1) thermostability and (2) co-factor dependency. Indeed, some thermostable DNA ligases are able to catalyse the DNA closing reaction at 72° C. and to remain stable after several incubation cycles at 95° C., similarly to thermostable polymerases. Therefore, these enzymes are compatible with PCR temperatures and can be directly included in the reaction mix. Regarding the co-factor dependency, such a feature also appears critical for optimal reaction. Indeed, there is two major families of DNA ligases that are able to use either ATP or NAD as co-factor. However in this particular case, a thermostable NAD-dependent ligase, such as the HiFi® Taq DNA ligase, would be preferred to an ATP-dependent ligase. In contrast to NAD, ATP is structurally close to dATP and can be incorporated in the newly synthetized DNA strand by the polymerase during PCR cycles. Such a phenomenon would be very harmful since ATP is a ribonucleotide whose incorporation in place of dATP may lead to spontaneous hydrolysis of DNA.

This one-pot method performs two steps in on cycle, consisting of an amplification step by PCR and a circularization step by DNA-ligation. Both steps are implemented by means of the device 10 according to the current invention.

### One-Pot PCR/Circularization

### Materials

thermocycled synthesis device 10,
PolyEthersulfone (PES) membrane 28 with a cut-off of 100 kDa,
Phosphorylated Primers (forward and reverse),
Plasmid DNA or minicircle template (>2.5 kb),
High fidelity Polymerase (e.g., Q5® High-fidelity DNA polymerase, from New England Biolabs),
PCR buffer,
dNTPs mix,
NAD-dependent thermostable ligase (e.g., HiFi® Taq DNA ligase),
NAD solution,
DNase-free water.

After at least one PCR/circularization cycle (denaturation at 95° C./annealing between 55-65° C./elongation at 72° C. and circularisation at 72° C.), there is the possibility to filtrate 35 the reaction solution by means of the filter membrane 28 in activating the evacuation system 18 and thus to remove the primer, the dNTPs, the polymerase, the NAD, the ligase, the salts and to go to the next step or repeat another cycle to increase the amount of DNA product and to remove harmful by-products. In the latter case, the reaction solution allows to renew the medium and to add fresh enzymes and to repeat cycles as many times as necessary to obtain a maximum amount of plasmid without having to use bacterial cell.

### Linear PCR Amplification

An alternative method which can be implemented using the device 10 of the invention includes linear PCR amplification. This process resembles the PCR-prep method described above, but does not comprise any circularization step. In other words, this process comprises the steps described for “Amplification phase 34 by PCR” above. The starting material may also not be a plasmid DNA or a minicircle template, but can alternatively be a linear nucleic acid template.

One particular example of linear PCR amplification is described in US 2021-0054384 A1, which is hereby incorporated by reference in its entirety. In particular, the method can comprise a step of obtaining a desired template DNA sequence containing the sequence of the gene of interest, optionally flanked by ITR sequences; then, using PCR primer pairs (forward and reverse), performing a PCR amplification as described above to produce a plurality of amplicons containing the desired sequence of the gene of interest, optionally flanked by ITR sequences. These amplicons can then be used for AAV vector production, according to methods well known in the art and mentioned above.

Other methods which can be implemented using the device 10 of the invention include RNA polymerization and “one-pot” RNA synthesis.

### RNA Polymerization

In a first step, one or more copies, in a single-stranded DNA form, of the complementary strand of a gene to be transcribed, are provided.

Synthesis cycles can be carried out, comprising three successive steps which can be repeated several times (e.g., from 1 to 20, 30, 40, 50 or more times, or until a desired amount of final product is obtained):
a. denaturation at 95° C. of the complementary strand of a gene to be transcribed, in the presence of an RNA primer specific to the 3′ end of this complementary strand and of a thermostable RNA polymerase (e.g., the mutated Tgo DNA polymerase from Thermococcus gorgonarius described by Cozens et al., 2012. Proc Natl Acad Sci USA. 109(21):8067-72);
b. hybridization of the RNA primer on the complementary strand at a temperature ranging from about 50° C. to about 70° C.;
c. synthesis of the messenger RNA strand, complementary to the template ssDNA strand, by the polymerase, at temperatures ranging from about 60° C. to about 75° C.

Filtration of the reaction medium can be carried by means of the filter membrane 28 in activating the evacuation system 18, in order to remove salts, nucleotides and the polymerase. Filtration can be repeated twice, three times or more, by adding water or buffer onto the sample in the at least one well 14 or in the reaction tube inside the at least one well 14, in order to wash the reaction product.

Finally, the reaction product can be incubated inside the at least one well 14 or in the reaction tube inside the at least one well 14, in the presence of an enzyme mixture able to perform a 5′ capping and a 3′ poly-adenylation to the newly produced messenger RNA, before additional rounds of washing by successive addition of water or buffer and filtration by means of the filter membrane 28 in activating the evacuation system 18; and optionally, of DNAse/protease treatment; before ultimately recovering the messenger RNA strands.

### “One-Pot” RNA Synthesis

In a first step, one or more copies, in a single-stranded DNA form, of the complementary strand of a gene to be transcribed, are provided. This complementary strand should have a plurality of deoxythymidine at their 5′ end, preferably contiguous, preferably from about 200 to about 300.

In a second step, synthesis cycles can be carried out, comprising three successive steps which can be repeated several times (e.g., from 1 to 20, 30, 40, 50 or more times, or until a desired amount of final product is obtained):
a. denaturation at 95° C. of the complementary strand, in the presence of a 5′ capped RNA primer specific to the 3′ end of this complementary strand and of a thermostable RNA polymerase (e.g., the mutated Tgo DNA polymerase from Thermococcus gorgonarius described by Cozens et al., 2012. Proc Natl Acad Sci USA. 109(21):8067-72);
b. hybridization of the RNA primer on the complementary strand at a temperature ranging from about 50° C. to about 70° C.;
c. synthesis of the messenger RNA strand, complementary to the template ssDNA strand, by the polymerase, at temperatures ranging from about 60° C. to about 75° C.

Filtration of the reaction medium can be carried by means of the filter membrane 28 in activating the evacuation system 18, in order to remove salts, nucleotides and the polymerase. Filtration can be repeated twice, three times or more, by adding water or buffer onto the sample in the at least one well 14 or in the reaction tube inside the at least one well 14, in order to wash the reaction product.

Finally, the reaction product can be incubated inside the at least one well 14 or in the reaction tube inside the at least one well 14, in the presence of an enzyme mixture able to perform a 5′ capping and a 3′ poly-adenylation to the newly produced messenger RNA, before additional rounds of washing by successive addition of water or buffer and filtration by means of the filter membrane 28 in activating the evacuation system 18; and optionally, of DNAse/protease treatment; before ultimately recovering the messenger RNA strands.

In any of the above embodiment, and depending on the reaction carried out, the reaction product may be recovered either in the well 14 as it remains captive from the membrane 28 after the activation of the evacuation system 18, or it can be recovered from the collector, if it is the remaining reaction solution which is held captive from the membrane 28. This is the case when the reaction inside the well 14 includes some cell culture or some bigger molecule degradation in order to obtain a smaller molecule of interest.

At the end of the method, the device 10 can be used as a direct storage device (−20° C. or −80° C.).

The present invention is thus very suitable for the handy, safe, automatized and efficient chemical and/or biochemical synthesis of macromolecules and small molecules bound to an organic and/or inorganic support. Each well 14 of the reaction plate 12 forms an independent synthesis chamber whose agitation and temperature are controlled, is more particularly suitable for the synthesis of polymers, such as nucleic acids, requiring cyclic chemical and/or biochemical reactions, comprising a step of addition of the reagents of synthesis, said reaction, followed by the elimination of the excess reagents as well as of the by-products of the reactions and this, in a repeated manner until the polymer of the desired size is obtained.

1. A thermocycling multistep reactions device comprising:
a reaction plate comprising at least one well configured to receive a reaction solution or a reaction tube,
a first fluid circuit and a second fluid circuit each one configured to maintain a fluid at a predetermined temperature,
at least one internal thermoregulating fluid circulation circuit configured to be arranged in direct contact with the at least one well, the thermoregulating fluid circuit being selectively connectable to the at least first fluid circuit and the second fluid circuit,
an evacuation system,
a control unit configured to manage the selectable connection of the at least two first fluid circuit and the second fluid circuit to the internal thermoregulating fluid circuit in order to regulate and control the temperature inside the at least one well, wherein each of the at least one well is connected to the evacuation system by means of at least one filter membrane, and
wherein the thermoregulating fluid circuit is made of a heat conducting material while the reaction plate is made of a polymerous material, the reaction plate at least partially enclosing the thermoregulating fluid circuit in order to at least partially isolate said thermoregulating fluid circuit from the external environment.

2. The thermocycling multistep reactions device according to claim 1, wherein each of the at least one well and the internal thermoregulating fluid circulation circuit are comprised in a same plane, said plane being defined by the reaction plate.

3. The thermocycling multistep reactions device according to claim 1, wherein the reaction plate is configured to enable a radial heat diffusion between each of the at least one well and the thermoregulating fluid circuit, said diffusion being thus parallel to the plane defined by the reaction plate.

4. The thermocycling multistep reactions device according to claim 1, wherein the reaction plate further encloses the evacuation system in order to at least partially isolate said evacuation system from the external environment.

5. The thermocycling multistep reactions device according to claim 1, wherein each of the at least one well displays an internal and an external surface, the external surface of each of the at least one well being in direct contact with the thermoregulating fluid circuit.

6. The thermocycling multistep reactions device according to claim 5, wherein the external surface of each of the at least one well is defined within the reaction plate, the reaction plate thus comprising the external surface of each of the at least one well.

7. The thermocycling multistep reactions device according to claim 1, wherein each of the at least one well is defined within the thermoregulating fluid circuit, the thermoregulating fluid circuit thus comprising an external surface of each of the at least one well.

8. The thermocycling multistep reactions device according to claim 1, wherein any heat diffusion between each of the at least one well and the thermoregulating fluid circuit is a direct diffusion.

9. The thermocycling multistep reactions device according to claim 1, wherein the reaction plate, the evacuation system and the thermoregulating fluid circuit are separable from each other.

10. The thermocycling multistep reactions device according to claim 1, wherein the first fluid circuit defines a first predetermined temperature ranging from about 90 to about 110° C.

11. The thermocycling multistep reactions device according to claim 1, wherein the second fluid circuit defines a second predetermined temperature ranging from about −150 to about 20° C.

12. The thermocycling multistep reactions device according to claim 1, wherein the device comprises one filter membrane for each of the at least one well, each filter membrane connecting its corresponding well to the evacuation system.

13. The thermocycling multistep reactions device according to claim 1, wherein dimensions of the thermocycling multistep reactions device comprise a height of 14 cm or less.

14. A thermocycling multistep reactions system comprising the thermocycling multistep reaction device according to claim 1 and a pipetting robot, the pipetting robot configured to fill or refill in an independent and automated way each of the at least one wells of the thermocycling multistep reactions device.

15. A thermocycling multistep reaction method implemented by means of the thermocycling multistep reactions device according to claim 1, said method comprising, in the order of listing, following steps:
filling the fluid circuits with one or several heat transfer fluid(s) and activating them,
filling each of the at least one well with either a reaction solution or a reaction tube comprising the reaction solution,
selectively activating and disactivating over time, by means of the control unit, the first fluid circuit and the second fluid circuit according to a predetermined reaction protocol,
activating the evacuation system when all the reaction steps according to reaction protocol are completed, and
recovering the reaction product held captive in the membrane or collected in the collector.

16. The thermocycling multistep reaction method, further comprising inserting a reaction tube inside the at least one well and positioning the at least one filter membrane between the at least one well and the evacuation system, wherein the inserting occurs after the filling of the fluid circuits and prior to the filling of each of the at least one well.
